(19) United States
(12) Patent Application Publication
(10) Pub. No.: US 2009/0114457 A1
(43) Pub. Date: May 7, 2009

(54) Object detection for a capacitive ITO touchpad

(76) Inventor: Jia-Yih Lii, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/987,922

(22) Filed: Dec. 6, 2007

(30) Foreign Application Priority Data
Nov. 1, 2007 (TW) 096141225

(51) Int. Cl. G06F 3/044

(52) U.S. Cl. 178/18.06

(57) ABSTRACT

In the detection of multiple objects touching on a capacitive ITO touchpad, the relative levels of the capacitive measurements received by a touch integrated circuit are used to determine the relative position between the multiple objects.

### FIELD OF THE INVENTION

The present invention generally relates to a capacitive ITO (Indium Tin Oxide) touch pad and more particularly, to an object detection for a capacitive ITO touch pad

### BACKGROUND OF THE INVENTION

Accommodating the trend of lightweight and thinness of electronic apparatus, capacitive touch pads have been applied to increasing applications. FIG. 1 and FIG. 2 Show a one-dimensional capacitive touch pad 10 including a sensor 12 having a plurality of sensing lines 1 to E and a touch IC 14. When a finger 16 touches the sensor 12 such as the sensing lines from 5 to 8, as shown in FIG. 1, the touch IC 14 will detect the change of the capacitive measurements of the sensing lines from 5 to 8 to determine the location of the finger 16. The touch IC 14 transforms the change of the capacitive measurements by an analog-digital transformation and then a sensed value graph as shown in the right portion of FIG. 1 is obtained, wherein the larger sensed values are represented by the longer histograms. When two fingers 16 and 18 touch the sensor 12 at the same time, as shown in FIG. 2, the touch IC 14 will detect the change of the capacitive measurements of the sensing lines from 2 to 5 and from 9 to C to determine the location of the fingers 16 and 18, as shown in the sensed value graph in the right portion of FIG. 2. FIG. 3 shows a two-dimensional capacitive touch pad 20 including a sensor 22 having a plurality of horizontal and vertical sensing lines and a touch IC 24. As mentioned above, the touch IC 24 will detect the change of the capacitive measurements of the sensor 22 to determine the location of the fingers 26 and 28. Besides, the sensor 22 includes sensing lines of two directions and thus the touch IC 24 will detect the capacitive measurements of vertical and horizontal directions, as shown respectively in the left and right sensed value graphs in FIG. 3.

FIG. 4 and FIG. 5 show the location of two fingers 32 and 34 on a touch pad 30. In FIG. 4, the location of the finger 32 is (X1, Y1) while the location of the other finger 34 is (X2, Y2). In FIG. 5, the location of the finger 32 is (X1, Y2) while the location of the other finger 34 is (X2, Y1). Conventional sensors of capacitive touch pads are disposed on a PCB or a FPC, which has small conducting resistance. Thus, the touch IC derives almost the same waveform shape no matter which coordinate location on the sensor is touched by the finger. Therefore, when two fingers 32 and 34 touch the touch pad 30, the touch IC can not identify that the relative locations of the fingers 32 and 34 are currently as FIG. 4 or FIG. 5 because the waveform shapes for both cases are similar. Consequently, some particular gestures can not be determined, such as the gesture that a finger stays still while another is rotating therearound.

Therefore, it is desired an object detection for determining relative location of finger on the touch pad.

### SUMMARY OF THE INVENTION

One objective of the present invention is to provide an object detection for a capacitive ITO touch pad

Another objective of the present invention is to provide a method for detecting the relative positions of a plurality objects on a touch pad.

According to a preferred embodiment of the present invention, a capacitive ITO touch pad includes an ITO sensor having a plurality of sensing lines, and a touch IC connecting the ITO sensor to detect the change of the capacitive measurements of the ITO sensor. According to the magnitude of the change of the capacitive measurements generated by touching the ITO sensors by the plurality of the objects, the touch IC is used to determine the relative positions of the plurality of objects.

### BRIEF DESCRIPTION OF THE DRAWINGS

These and other objects, features and advantages of the present invention will become apparent to those skilled in the art upon consideration of the following description of the preferred embodiments of the present invention taken in conjunction with the accompanying drawings, in which:

FIG. 1 shows a one-dimensional touch pad and the change of capacitive measurement thereon;

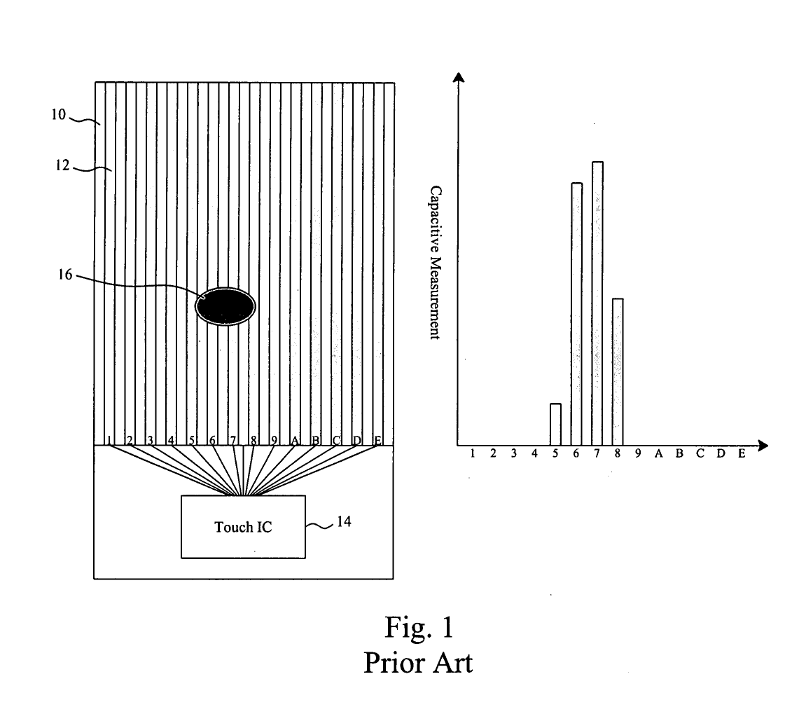

FIG. 2 shows a one-dimensional touch pad and the change of capacitive measurement thereon;

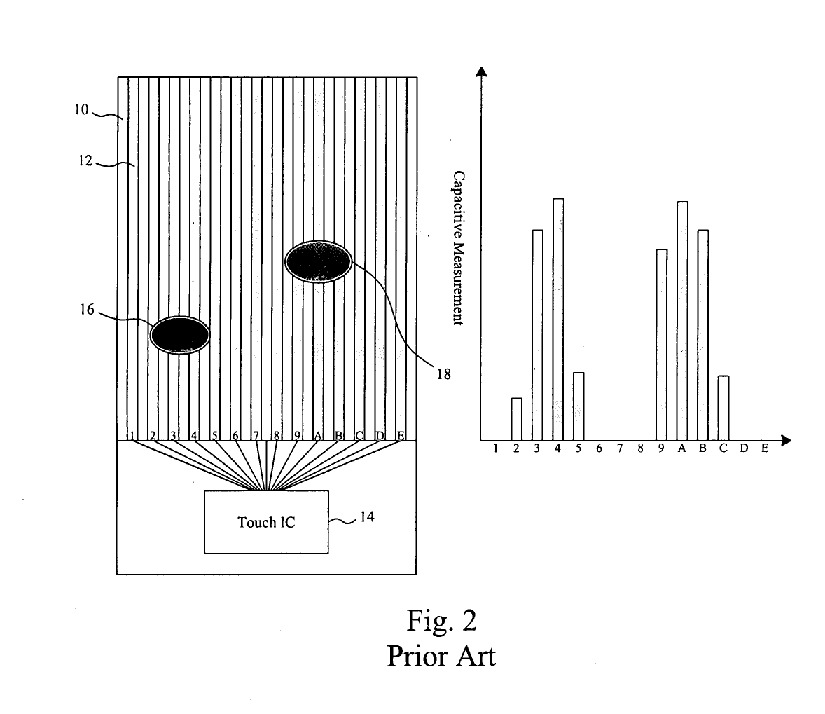

FIG. 3 shows a two-dimensional touch pad and the change of capacitive measurement thereon;

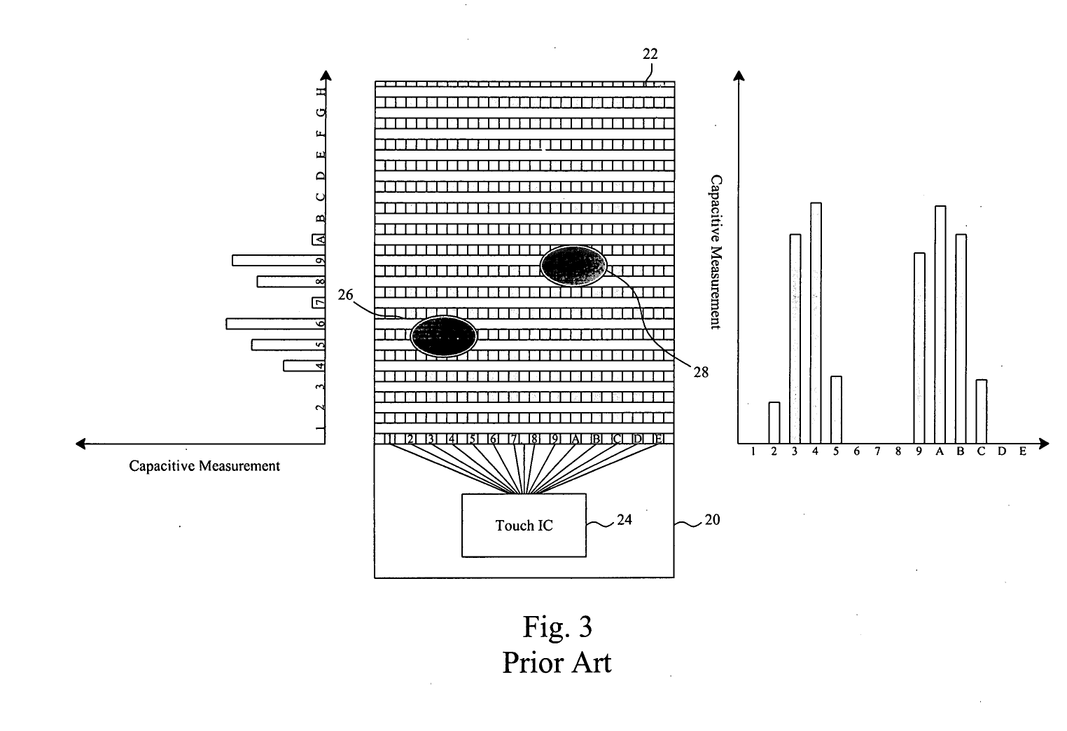

FIG. 4 shows a first condition of fingers on a touch pad;

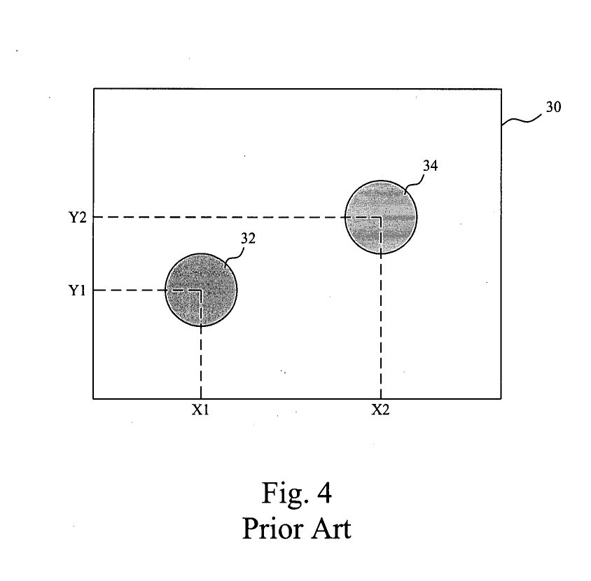

FIG. 5 shows a second condition of fingers on a touch pad;

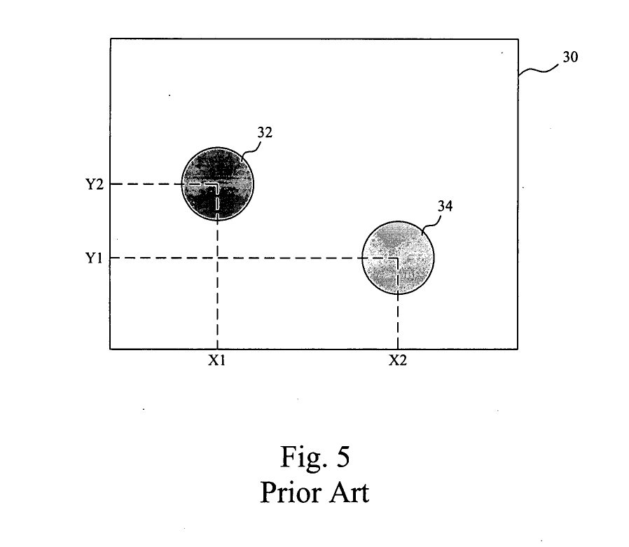

FIG. 6 shows the first preferred embodiment of the present invention; and

FIG. 7 shows the second preferred embodiment of the present invention.

### DETAIL DESCRIPTION OF THE INVENTION

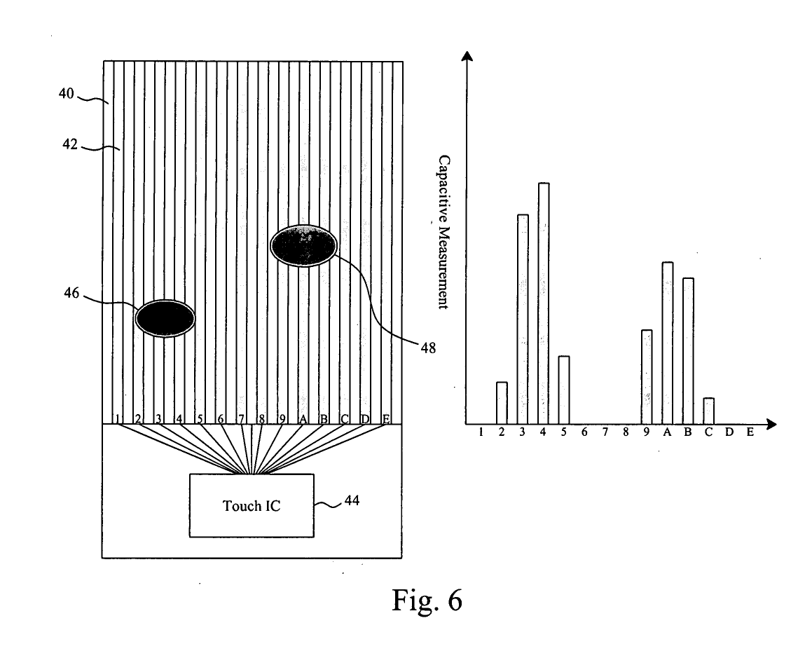

FIG. 6 shows the first preferred embodiment of the present invention. In a one-dimensional capacitive ITO touch pad 40, an ITO sensor 42 has a plurality of sensing lines from 1 to E, and a touch IC 44 connects the sensing lines from 1 to E of the ITO sensor 42. Generally, the location where the ITO sensor 42 connects the touch IC 44 is the origin of the coordinates. When fingers 46 and 48 touch the ITO sensor 42, the touch IC 44 will detect the change of capacitive measurements of the ITO sensing lines from 2 to 5 and from 9 to C, and then a sensed value graph is obtained as shown in the right portion of FIG. 6. The sensing lines from 1 to E are ITO, and therefore have a relatively large resistance. Thus, when the distances of the fingers 46 and 48 with respect to the origin are different, the capacitive measurements thereof detected by the touch IC 44 will be obviously different. As shown in the sensed value graph in the right portion of FIG. 6, the touch IC 44 detects that the capacitive measurement of the finger 46 is larger than that of the finger 48, and thus the touch IC 44 can determine that the finger 46 is closer to the origin than the finger 48. Further, the fact that the finger 46 is below the finger 48, or the finger 48 is above the finger 46 can be determined by the touch IC 44.

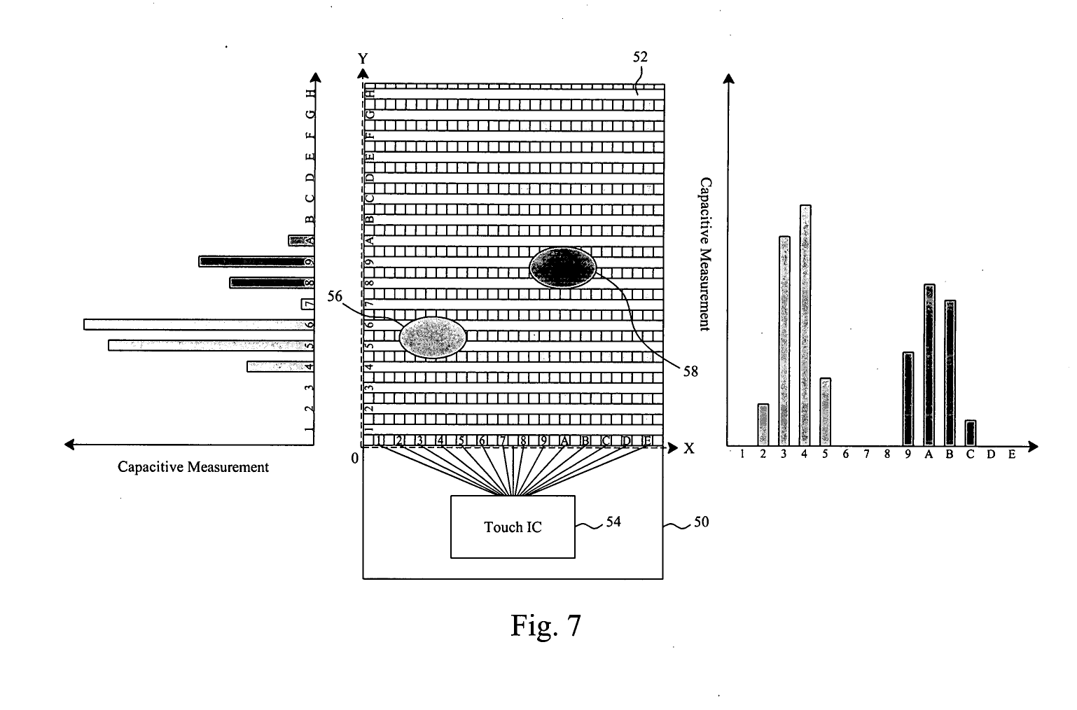

FIG. 7 shows the second preferred embodiment of the present invention. In a two-dimensional capacitive ITO touch pad 50, an ITO sensor 52 has a plurality of horizontal and vertical sensing lines. A touch IC 54 connects the plurality of horizontal and vertical sensing lines of the ITO sensor 52. In this embodiment, the touch IC 54 connects to the left ends of the horizontal sensing lines and lower ends of the vertical sensing lines, and thus the origin of x-coordinate is at the left and the origin of y-coordinate is at the underside. When the fingers 56 and 58 touch the ITO sensor 52, the touch IC 54 will detect the change of capacitive measurements of the vertical and horizontal directions as shown in the left and right sensed value graphs in FIG. 7. The ITO sensing lines have larger resistance and therefore when the finger is closer to the origin of coordinates, the detected capacitive measurement is larger. It can be learned from the sensed value graph in the left of the FIG. 7 that the touch IC 54 detects that the capacitive measurement of the finger 56 in the vertical direction is larger than that of the finger 58, and thus determines the finger 56 is located nearer the left. In other words, the x-coordinate location of the finger 56 is closer to the x-coordinate origin. It can be also learned from the sensed value graph in the right of the FIG. 7 that the touch IC 54 detects that the capacitive measurement of the finger 56 in the horizontal direction is larger than that of the finger 58, and thus determines the location of the finger 56 is nearer the underside. In other words, the y-coordinate location of the finger 56 is closer to the y-coordinate origin. Thus, by the characteristic of the ITO resistance, the touch IC 54 can determine that the finger 56 is below and at the left of the finger 58, and the finger 58 is above and at the right of the finger 56.

The two-dimensional touch pad 50 determines the relative locations of the fingers 56 and 58 by the capacitive measurements in vertical and horizontal directions. In other embodiments, the relative locations of the fingers 56 and 58 can be determined by the capacitive measurements in either vertical or horizontal direction. For example, from the sensed value graph in the right portion of FIG. 7, two fingers 56 and 58 are on the touch pad 50, and the capacitive measurement of the left graph is larger than that of the right one. Thus the finger 56 at the left is determined closer to the underside and then it is determined that the finger 56 is below and at the left of the finger 58 while the finger 58 is above and at the right of the finger 56.

While the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation to encompass all such modifications and similar arrangements.

What is claimed is:

1. An object detection for a capacitive ITO touch pad, comprising the steps of:
detecting magnitude of a plurality of capacitive measurements generated when a plurality of objects touch the touch pad; and
determining relative locations of the plurality of objects according to the magnitude of the plurality of capacitive measurements.

2. An object detection for a capacitive ITO touch pad, comprising the steps of:
detecting magnitude of a plurality of capacitive measurements in a first and a second directions generated when a plurality of objects touch the touch pad;
determining relative locations of the plurality of objects in the second direction according to the magnitude of the plurality of capacitive measurements in the first direction; and
determining relative locations of the plurality of objects in the first direction according to the magnitude of the plurality of capacitive measurements in the second direction.

3. An object detection for a capacitive ITO touch pad, comprising the steps of:
generating a plurality of capacitive measurements in a first direction and a second direction when a plurality of objects touching the touch pad;
determining relative locations of the plurality of objects in the first direction according to relative locations of the plurality of capacitive measurements in the first direction; and
determining relative locations of the plurality of objects in the second direction according to the magnitude of the plurality of capacitive measurements in the second direction.

4. A capacitive ITO touch pad, comprising
a sensor having a plurality of ITO sensing lines for generating a plurality of capacitive measurements when a plurality of objects touch; and
a touch IC connecting the sensor for detecting the capacitive measurements from the sensor;
wherein, magnitude of the plurality of capacitive measurements is used to determine relative locations of the plurality of objects.

5. The capacitive ITO touch pad as claimed in claim 4, wherein the plurality of ITO sensing lines are disposed in one direction.

6. The capacitive ITO touch pad as claimed in claim 4, wherein the plurality of ITO sensing lines are disposed in a first and a second directions.

7. The capacitive ITO touch pad as claimed in claim 6, wherein the first and the second directions are mutually perpendicular.

8. The capacitive ITO touch pad as claimed in claim 6, wherein magnitude of the plurality of capacitive measurements in the first direction is used to determine the relative positions of the plurality of objects in the second direction.

9. The capacitive ITO touch pad as claimed in claim 8, wherein magnitude of the plurality of capacitive measurements in the second direction is used to determine the relative positions of the plurality of objects in the first direction.

10. The capacitive ITO touch pad as claimed in claim 8, wherein relative positions of the plurality of capacitive measurements in the first direction is used to determine the relative positions of the plurality of objects in the first direction.
